(19) United States
(12) Patent Application Publication
(10) Pub. No.: US 2026/0290286 A1
(43) Pub. Date: Sep. 24, 2026

(54) ADJUSTABLE GUITAR NUTS

(71) Applicant: Becket COLON, Drottningholm (SE)

(72) Inventor: Becket COLON, Drottningholm (SE)

(21) Appl. No.: 19/474,314

(22) PCT Filed: Apr. 12, 2024
(86) PCT No.: PCT/US2024/024291

§ 371 Date: Oct. 10, 2025

Related U.S. Application Data
(60) Provisional application No. 63/459,118, filed on Apr. 13, 2023.

(51) Int. Cl. G10D 3/12

(52) U.S. Cl. CPC G10D 3/12

(57) ABSTRACT

Adjustable locking nuts, including zerofret nuts, for stringed instruments, are made of multiple materials. Adjustable locking nuts, including zerofret nuts, for stringed instruments, are color-coded.

### FIELD

The present invention relates to guitar nuts.

### BACKGROUND

Experts all concur that a guitar is an imperfect instrument, that it is impossible for it to play perfectly in tune. The reason is that guitars all feature a serious design flaw which causes them to play out of tune, they all lack the ability to adjust the instruments intonation at the nut.

A guitar and other fretted instruments are precision assemblies. In order to accurately play tones in half a semitone increments all across the fretboard, the strings and the Y axis location of the strings anchor points need to be individually calibrated to the correct values. A process commonly known as “Intonating” the strings. Small length adjustments which compensate for tension and strain properties of the string under tension.

Since proper intonation is tension and string property/material specific. Every time you switch the type, size or brand of strings or use a different tuning, you need intonate and adjust the instrument to match the new tension and string variables.

Intonation shortens or lengthens the string length by shifting the anchor points Y axis position. This enables the strings to properly map to the fretboard and accurately reproduce tones.

Adjustments at the bridge of the guitar map the strings and intonate from the 7^{th} fret and higher.

Adjustments at the nut map the strings and intonate the instrument from the 1^{st} through 6^{th} frets.

Almost all guitars feature an adjustable bridge, none of them have an adjustable nut.

A guitar nut has three purposes:
1. It anchors and positions the strings in the correct position
2. It channels string vibration energy into the instrument
3. It anchors the string in a specific X, Y, and Z coordinate. The location of this coordinate, governing intonation.

All guitar nuts of static design, they are typically made from a single material or material composite, it is not possible to intonate the instrument as the anchor point is fixed.

There are primarily two types of nuts,
1. Straight edge nuts where the front edge of the nut also functions as the anchor point which fixes X, Y, Z, position of the string's breakpoint.
2. Compensated nuts which feature offset anchor points in the Y axis responsible for string intonation from the first through 6^{th} frets. Internal compensated nuts have the anchor point within the nut body, while shelf compensated nuts extend the string partition over the fingerboard.

Instruments with standard straight edge nuts never intonate properly. Instruments equipped with Ernie Ball's internal compensated nut or Earvana's Compensated shelf nut intonate properly only if the correct string gauge/properties and tuning are used.

Since players are constantly using different strings and tunings, they need an instrument where both anchor points can be adjusted.

In addition to string positioning, the nut material plays an important role in amplifying the sound of the instrument. As a result, nuts are typically made from high density materials, such as bone, metal as well as fiberglass and/or metal powder reinforced plastic resin.

An additional consideration is the tribological values of the nut material. Guitar strings are constantly bent, stretched and glide within the string slot while playing. It is a common that the strings catch and adhere to the nut, binding the string to the to the nut material, causing it to play out of tune. This is why some companies use lubricant additives in their plastic guitar nuts such as graphite, PFTE, silicone, etc. to minimize friction between the string and the nut material.

The size of the string slots is also important, the diameter of the slot should match the diameter of the string that the slot is retaining and positioning in place. While it is possible to use a smaller diameter string in a wider diameter string slot, it is not possible to use a larger diameter string in a narrow slot. The string will not seat at the proper depth and will not play or stay in tune.

Nut density is also important, as dense nut materials are typically superior in transferring the vibrational energy from the strings into the instrument.

There are 3 main types of guitar nuts.
1. A standard nut with string slots. Made from Bone, Brass, Plastic, etc.
2. Locking tremolo units. Which guide and lock the strings in position preventing string movement and tension changes.
3. Zero fret nuts. A ZEROFRET is a Guitar fret placed in the “Zero position”, at the beginning of the neck, usually directly in front of a standard nut which hold the string in place. This type of nut is popular with headless guitars.

There are problems with all three designs.

To begin with the straight edge nuts design common to all these nuts, causes the instrument to play out of tune, and since they all lack adjustability options, it is not possible to intonate the instrument.

Another problem is material. Standard nuts are typically produced with hard and dense materials in order to enhance energy transference between the vibrating string and the instrument. Bone and synthetic bone are the most popular materials for this type of nut. Bone is an abrasive material by nature and synthetic bone is produced adding fiberglass powder or metal particles to the plastic resin to improve density.

Lubricants are typically added to nuts to minimize string binding. Oil lubricants have been used for centuries with bone nuts, while modern synthetic bone nuts feature PFTE, graphite and silicone.

Unfortunately, these lubricant additives combined with the inherent properties of many of the resins used make installing these nuts difficult as there are few adhesives which work.

Then there are the problems and implications of using abrasive materials, despite lubrication, the nut material remains an abrasive.

By designing a nut made from multiple materials it is possible to receive the benefits of both a dense and lubricated nut.

### DETAILED DESCRIPTION

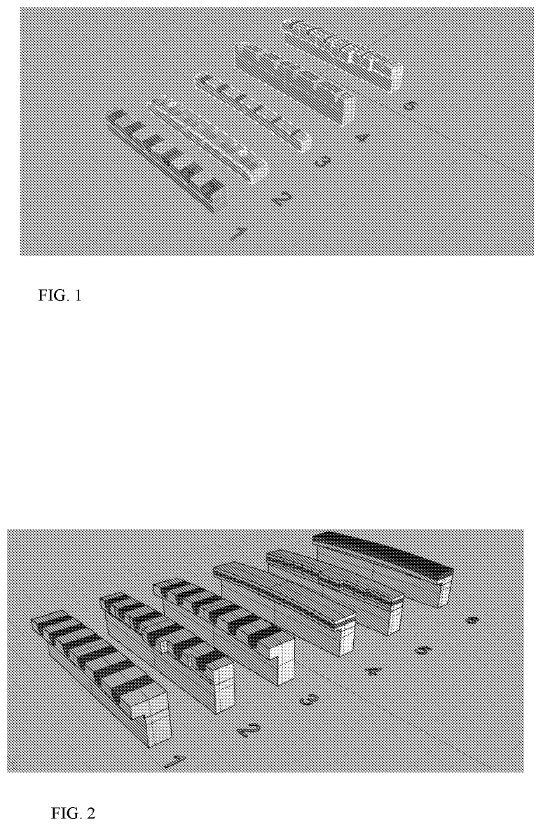

One exemplary standard nut design is visualized in FIG. 1 as “a multi material guitar nut” featuring high mechanical transference base material and low friction string slot material.

FIG. 2 shows a second example with both material pockets as well as material layers covering the entire nut body.

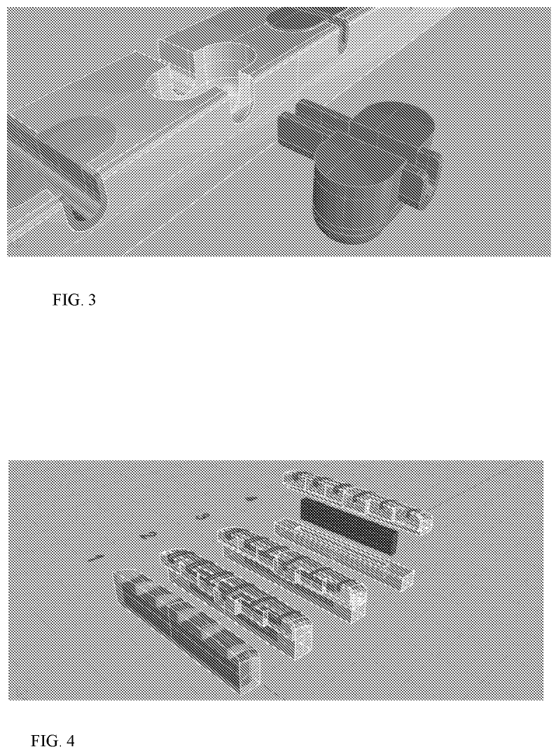

For milled nuts such as bone, aluminum, etc, a second material is added in the form of an insert. For example, FIG. 3 illustrates a milled aluminum nut with molded low friction lubricated plastic insert which are pressfit into the milled part forming the for the string partitions.

Another way of adding density to the nut without the addition of abrasives is to insert, over mold and encapsulate, a small block of high-density material such as tungsten, brass or some other dense material inside the nut. The addition of high-density material improves the mechanical transference.

With Bone and milled nuts, insertion of the high-density material can be done by milling or cutting a cavity in the part and then filling this cavity with the insert.

With injection molded plastic parts, the high density insert would be molded into the part, here it is possible to combine both glass and metal filled resins with a high density insert to achieve unprecedented density.

This innovation applicable to guitar nuts and bridges and bridge saddle components.

Another benefit of Insert molding is that it also solves the problem of plastic adhesion. It is difficult to glue plastic nuts there are no glues that adhere well to plastic nuts, (one of the main reasons why people still use bone).

By placing the high density insert against the leading edge or the bottom of the part you create an adhesive surface which facilitates installation.

FIG. 4 illustrates an X-Ray visualization of a series of nuts featuring bone, brass and tungsten inserts. The inserts are molded inside the parts in different positions depending upon the type and design of the nut slot of guitar they will be installed in. Here shown on the bottom of the part.

Nut Number 1 features 3 innovations, 1. Dense powder filled plastic resin, 2. dense metal insert inside part, place on the bottom for good adhesion and 3. multi material string slots.

Nut number 2 is a one-piece injection molded compensated nut featuring Dense powder filled plastic resin, dense metal insert inside part, place on the bottom for good adhesion and multi material string slots

Nut number 3 and 4 are the same. Number 4 is the exploded view. This nuts innovative feature is a top and bottom part featuring a female groove fitting, a high-density metal insert which mates and holds the parts together. This will be a good solution for 2-part nuts milled from bone, Delrin, etc.

In FIG. 5 you see parts with alternative geometry and placement. Instead of a solid bar, here an L shaped insert which creates gluing partitions on the bottom and leading edge of the part. Same innovations, glass/metal filled resin, high density insert, low friction string partitions.

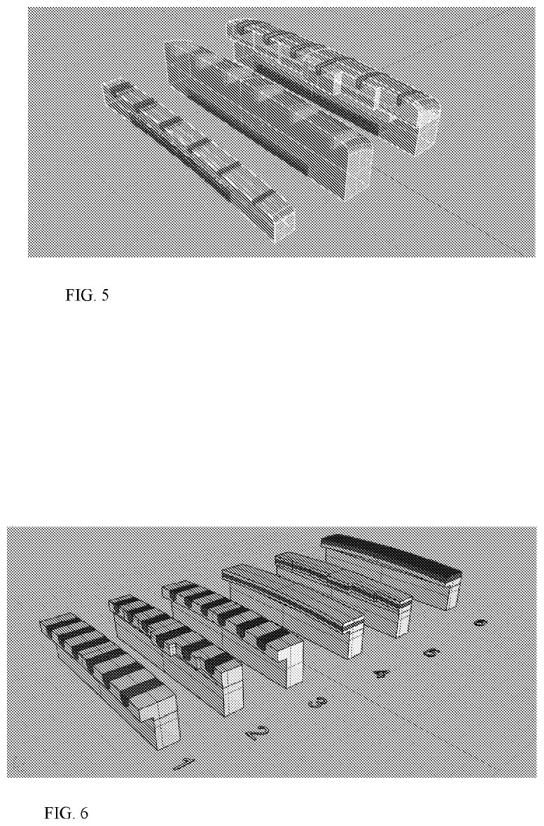

The multi material nut design can also be suppled without string slots. Here the multi material can be implemented as individually shaped partitions as well as layers, as illustrated in FIG. 6.

Nut number 1 is a 2-piece compensated nut blank with different material in string partition area

Nut number 2 is a 2-piece pre compensated example of the same

Nut number 3 is a single piece compensated nut blank with differ material string partitions.

Nuts nr 4 thru 6 are nut versions where a layer of low friction material is molded into the part as a layer, here the main nut body a dense modified plastic with layers of low friction material in the string contact region of the nut.

By making the top layer of the part from colored Low friction materials, it is easy to identify the correct part.

Furthermore, by providing interchangeable nuts installable on a base installed to the guitar neck, the appropriate nut can easily be installed when, for example, one or more strings are changed. In particular, a compensated nut which improves the intonation of each string of a musical instrument regardless of string gauge, tension, construction and material. Advantageously, the nut saddle/saddles are compensated different amounts and interchangeable according to the desired pitch of a particular string. The compensated nut is suitable for use with a wide range of different string gauges, desired tensions, construction and materials for the most popular types of stringed musical instruments, the interchangeable saddle components clearly identified as to which string gauges, desired tension, material and construction they are best suited for. Because the saddles can easily be replaced or interchanged to accommodate different string properties, the player is not limited to fixed intonation values found in both standard nuts and standard fixed compensated nuts but is able to improve and maintain optimal intonation regardless of the choice of string tension and properties by simply interchanging the correct nut saddle component.

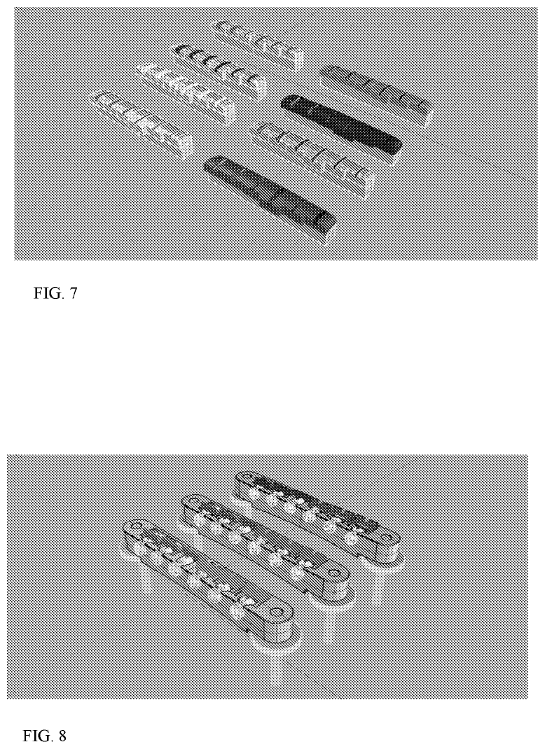

FIG. 7 illustrates examples of color coding innovation of the interchangeable parts.

As explained previously the string slot diameter has to match the strings, by color coding the nut it becomes easier to recognize and identify the correct part. The color becomes a way of recognizing and choosing the right size part.

This color coding can also be used on other components as well such as acoustic guitar bridge saddles and saddle and pole pieces on adjustable bridges, as illustrated in FIG. 8.

Adjustable bridge pole pieces and 2 k materials here the colored individual string saddles indicate the diameter of the string retention slots i.e. pink saddles equals 0.011-0.052 in strings, Red 0.010-0.046 and Blue 0.009-0.042. Color a way to organize, both bridge and nut parts.

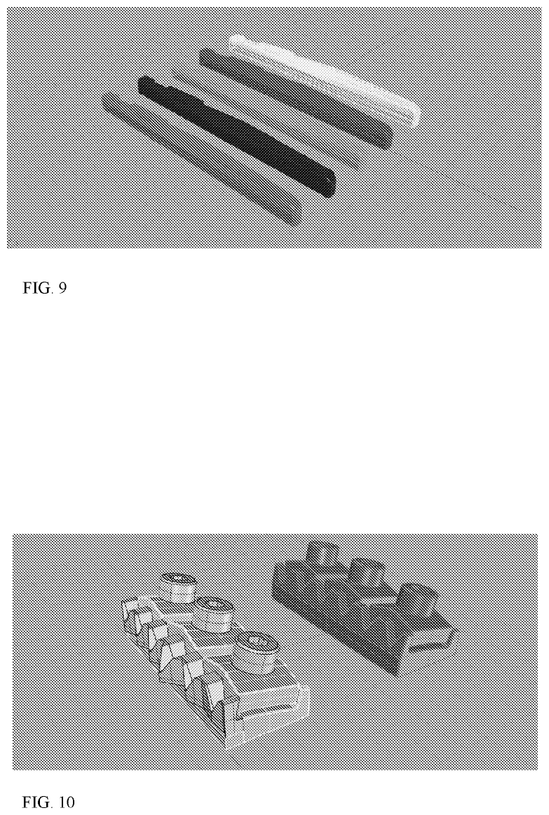

FIG. 9 illustrates compensated acoustic guitar saddles. Each saddle is compensated for a different compensation value to help discern the compensation value of the part and for visual differentiation.

Acoustic guitar saddles can be one piece. Multi material with high density body and low friction string contact section. The acoustic guitar saddles can have a high density insert molded into the part, or in case of bone hollowed out and filled with dense insert.

A locking tremolo nut is illustrated in FIG. 10 in assembled and the standard non compensated part it is intended to replace.

FIG. 11 is exploded view showing different color-coded compensation inserts for the assembly. Here again multiple innovations, 1. The replaceable compensated insert, 2. The low friction materials, multi material and single material 3. Insert molding to improve density. The Red, Blue and Green inserts offer different compensation values, when assembled the inserts interlocks with the base part.

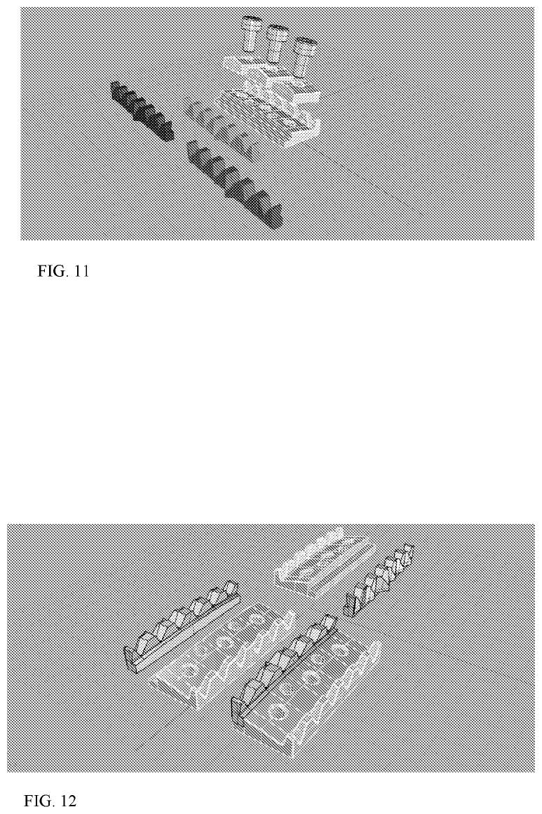

FIG. 12 illustrates the compensation insert and base interaction.

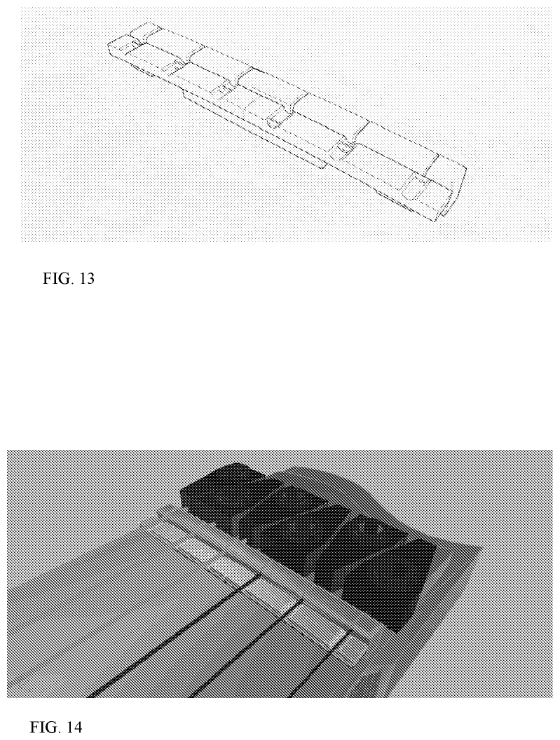

A zero fret nut system in stainless steel is illustrated in FIG. 13.

FIG. 14 illustrates a Steel zerofret with color coded polymer compensated upper portion. The polymer material lowing friction and eliminating string buzzing. The color helping to identify the nut used.

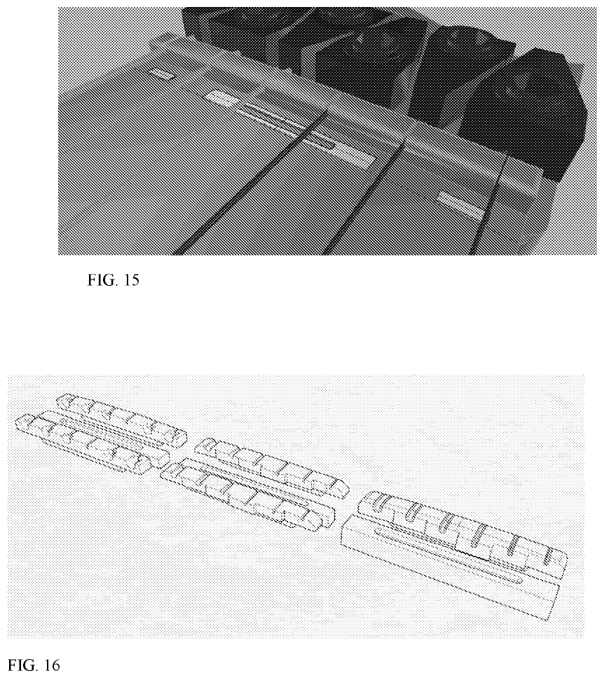

FIG. 15 illustrates a slot and magnet fitting for a zero fret nut. The center part is an embedded magnet and the side parts are slots for press fit of the zero fret nut.

FIG. 16 illustrates an example of a standard nut that is adjustable via a tongue-and-groove connection between the base and the nut, so that nuts designed for different string widths can be easily interchanged.

1-5. (canceled)

6. A nut for a stringed instrument, the nut comprises a string contact region and a base, wherein the base comprises a high density material to enhance energy transference between a vibrating string and the instrument, characterized in that the string contact region comprises a low friction material.

7. The nut according to claim 6, wherein a layer of the low friction material is molded into high density material.

8. The nut according to claim 6, wherein the nut includes an insert of the high density material.

9. The nut according to claim 8, wherein the insert of the high density material is inserted, over molded, or encapsulated inside the nut.

10. The nut according to any one of claim 8, wherein the insert of high density material is made of metal or bone.

11. The nut according to claim 10, wherein the metal is tungsten or brass.

12. The nut according to claim 6, wherein the low friction material is colored.

13. The nut according to claim 12, wherein a plurality of color-coded nuts are interchangeably installable on the stringed instrument.

14. The nut according to claim 6, wherein the high density material of the base is bone, metal, fiberglass, and/or metal powder reinforced plastic resin.

15. The nut according to claim 14, wherein the metal is aluminium.

16. The nut according to claim 6, wherein the low friction material is a polymer.

17. The nut according to claim 6, wherein the low friction material is any of the materials in the group consisting of: polytetrafluorethylene (PTFE) and silicone.

18. The nut according to claim 6, wherein the nut is an adjustable compensated guitar nut.

19. The nut according to claim 6, wherein the nut is a locking tremolo nut or a zerofret nut.
